(19) United States
(12) Patent Application Publication
(10) Pub. No.: US 2002/0131566 A1
(43) Pub. Date: Sep. 19, 2002

(54) Integrated telephone voice mail, electronic mail and audio play system and method

(76) Inventors: Richard M. Stark, Orono, MN (US); Reginald L. McNutt, Plymouth, MN (US); Daithi M. Haxton, Thorntown, IN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/091,180

(22) Filed: Mar. 5, 2002

Related U.S. Application Data
(60) Provisional application No. 60/273,750, filed on Mar. 6, 2001.

(51) Int. Cl. H04M 1/64; H04M 11/00; H04M 1/56; H04M 15/06

(52) U.S. Cl. 379/88.19; 379/93.24; 379/142.01

(57) ABSTRACT

A method and apparatus are provided to digitize an incoming telephone message, optionally compress the audio file to make the file smaller, optionally encrypt the file to make it secure, send the audio file as an electronic mail attachment with optional caller ID information to identify the caller, receive the electronic mail on a remote computer, and finally de-compress, de-encrypt and play the attached audio file through a sound card on the remote computer. A permanent electronic record of the voice mail is now available on the user's remote computer.

### FIELD

The present invention relates generally to voice mail systems and, in particular, to voice mail systems that store and forward voice mail.

### BACKGROUND

Voice mail systems are able to digitize and store incoming messages on a telephone system when a user is not present. In order to retrieve voice mail messages, the user typically calls into the voice mail system and plays the message remotely. If the user is out of the local calling area, then a costly long distance call may be required. Other disadvantages of typical voice mail systems include the lack of a permanent record for the incoming call.

Electronic mail is able to easily send digital information over the Internet to almost anywhere in the world. It has the advantage that a long distance call is not required to send this information over long distances. Audio files are increasingly being sent over the Internet in electronic mail as attachments; however, most of these files are sent in a “wave” format that typically requires a large file size. If a computer connects to the Internet with a standard telephone line analog modem, then the relative “connect rate” is slow and large files take a very long time to upload or download. Typically, a 16 bits/sample, 8 kHz or greater, sample rate audio wave file is sent, which results in a 128 kilobits per second (kbps) data stream for real time transmission. This can typically take six times the actual play time (real time) to send the file with analog modems. The size of the audio file can be reduced significantly if an audio compression scheme such as adaptive delta pulse code modulation (ADPCM) is used. Some ADPCM implementations are described in the International Telecommunications Union (ITU) standard G.726 entitled “40, 32, 24, 16 kbit/s adaptive differential pulse code modulation (ADPCM),” (Published December, 1990), hereinafter referred to as “ITU standard G.726.” The ITU standard G.726 implementation of ADPCM can reduce the sample size to 3, 4 or 5 bits/sample while still maintaining good sound quality. This creates a 24, 32 or 40 kbps data stream for near real time transmission. This results in a much quicker upload and download of the audio file, often between 1 and 1.5 times real time. Other audio compression schemes can be used with different degrees of sound quality and file size.

Many computers today have audio players and sound cards that are capable of playing standard wave files. A standard wave file attachment from an electronic mail can typically be played over the sound card by simply double-clicking on the attachment. Most computers today do not have a player capable of playing ADPCM sound files over the sound card. In this situation, a special application software may be required to play the ADPCM or other compressed sound file.

Accordingly, a significant need exists for methods and apparatus for efficient voice mail message retrieval.

### SUMMARY

A computer voice mail system is used to digitally capture an incoming audio message. A telephone interface device (TID) is used to interface the telephone line to the computer. The TID has the necessary hardware to answer incoming telephone calls on a standard analog telephone line. Software control of the TID is provided by an application program running on the computer. A USB interface on the TID allows easy connection to a computer and easy expansion for a multi-port system.

The voice mail system can provide one mail box per phone line/TID or it can provide multiple mail boxes by using dual tone multi-frequency (DTMF) signaling to communicate the desired mail box number. A voice directory of mail box users and associated box numbers can be played for the caller so that they can determine the correct mail box.

The voice mail application software can direct the TID to encode the audio as a standard wave file, as a compressed μlaw file, in one of the known compressed ADPCM formats per ITU standard G.726 or some other compressed format. Alternatively, the application can do any of the above audio compressions in software on the personal computer (PC). The digitized and compressed audio is stored in the computer memory for retrieval and play over the TID or optionally, the stored audio can be sent as an electronic mail attachment. Compressing the audio allows for smaller file sizes resulting in smaller storage requirements and faster upload and download times.

The voice mail application software allows the user to enter an electronic mail address for each mail box present in the voice mail system. Optionally, other electronic mail addresses can be added so that copies of the voice mail can be sent to more than one location. It also allows the user to specify the audio compression scheme and when to send the voice mail as an electronic mail attachment. The user can specify a fixed time interval to send electronic mail or electronic mail can be sent each time that an incoming message is received into voice mail.

The electronic voice mail may be optionally encrypted with a password. This increases the security for electronic mail sent over the Internet.

When an incoming voice mail is received and when the send electronic mail system is enabled, the system will attach the compressed audio message to a text message and send it to the specified email address. The text message may include a time and date stamp for the received voice mail and it also may include caller ID information. The caller ID information can be provided in the text body of the email and can optionally be displayed in the subject of the email. This allows the user to quickly identify the caller of the electronic voice mail. The computer can have a modem interconnect to a phone line or other Internet connection for transmittal of the audio email message over the Internet.

The user can receive his voice mail message via email by connecting a portable or other computer/modem to a telephone line or other Internet connection and downloading the email. If the user desires to play the attached voice mail message, application software can read, decompress, decrypt, and play the compressed audio file over the computer sound card. The application software can be optionally downloaded from a particular web page if the computer does not already have it installed. The voice mail message as part of the email attachment can be saved in any of the many computer storage options available. This allows for permanent storage, retrieval, transferring to another party and playing of the original voice mail message.

### BRIEF DESCRIPTION OF THE DRAWINGS

FIG. 1 is a block diagram of an integrated voice email system;

FIG. 2 is a block diagram of a voice email computer server;

FIG. 3 is a block diagram of a telephone interface device; and

FIG. 4 shows a flowchart of a method in accordance with various embodiments of the present invention.

### DESCRIPTION OF EMBODIMENTS

In the following detailed description, reference is made to the accompanying drawings that show, by way of illustration, specific embodiments in which the invention may be practiced. It is to be understood that various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted along with the full range of equivalents to which the claims are entitled. In the drawings, like numerals refer to the same or similar functionality throughout the several views.

Various embodiments of this invention provide a mechanism to retrieve voice mail messages with caller ID information using electronic mail over the Internet. The user can later retrieve this information with a portable or other computer connected to the Internet. The voice mail caller can be quickly identified with the optional caller ID information in the subject of the email. The message can be played, stored for further use, or sent to other individuals for their review.

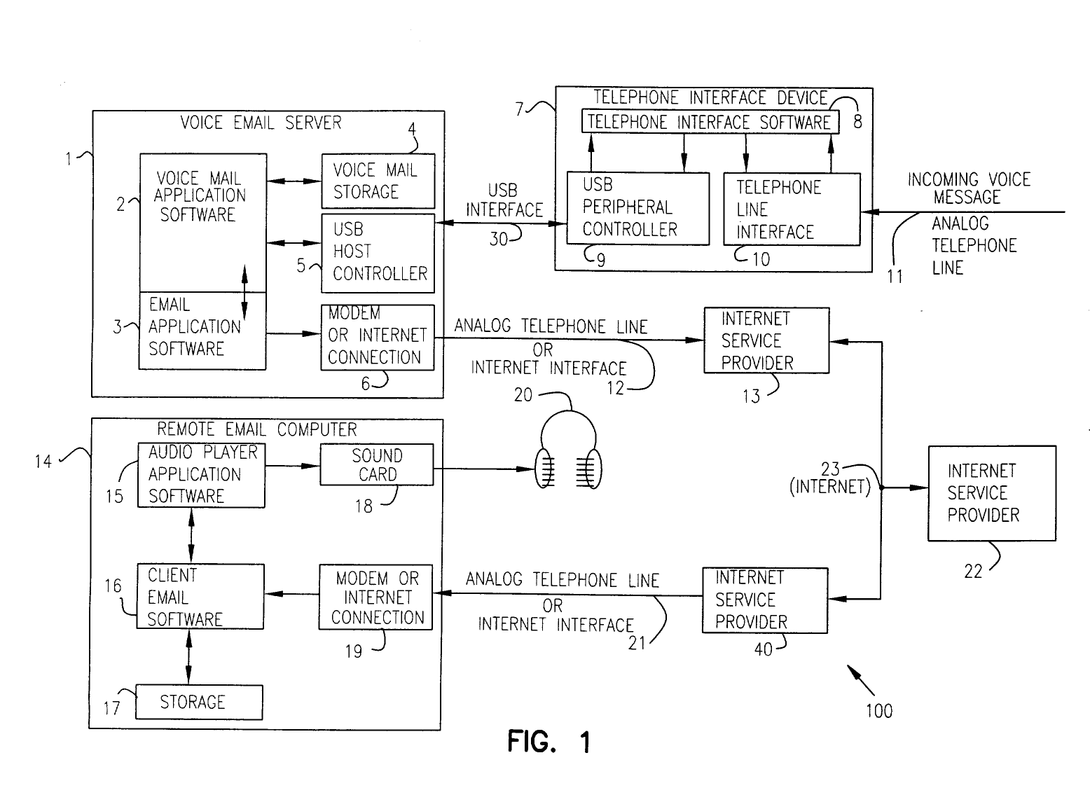

FIG. 1 shows an integrated voice email system. System 100 includes voice email server 1, telephone interface device (TID) 7, and remote email computer 14. System 100 is also shown with Internet service providers 13, 22, and 40.

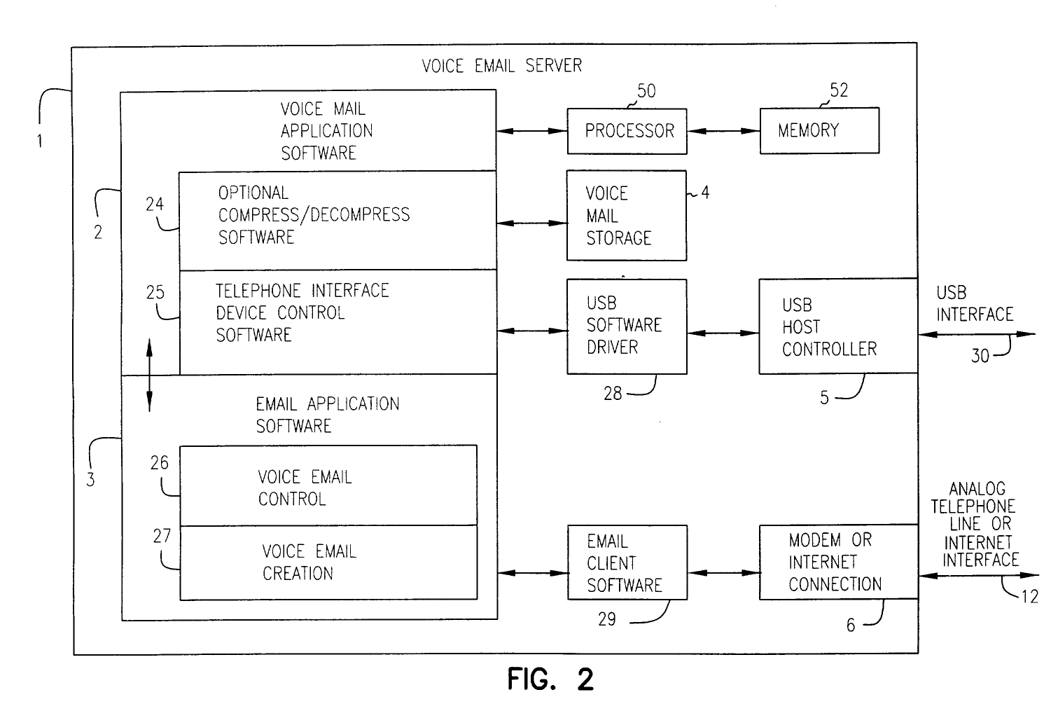

As shown in FIG. 1, voice email server 1 includes voice mail application software 2, email application software 3, voice mail storage 4, universal serial bus (USB) host controller 5, and modem or Internet connection 6. Voice email server 1 is described more fully below with reference to FIG. 2.

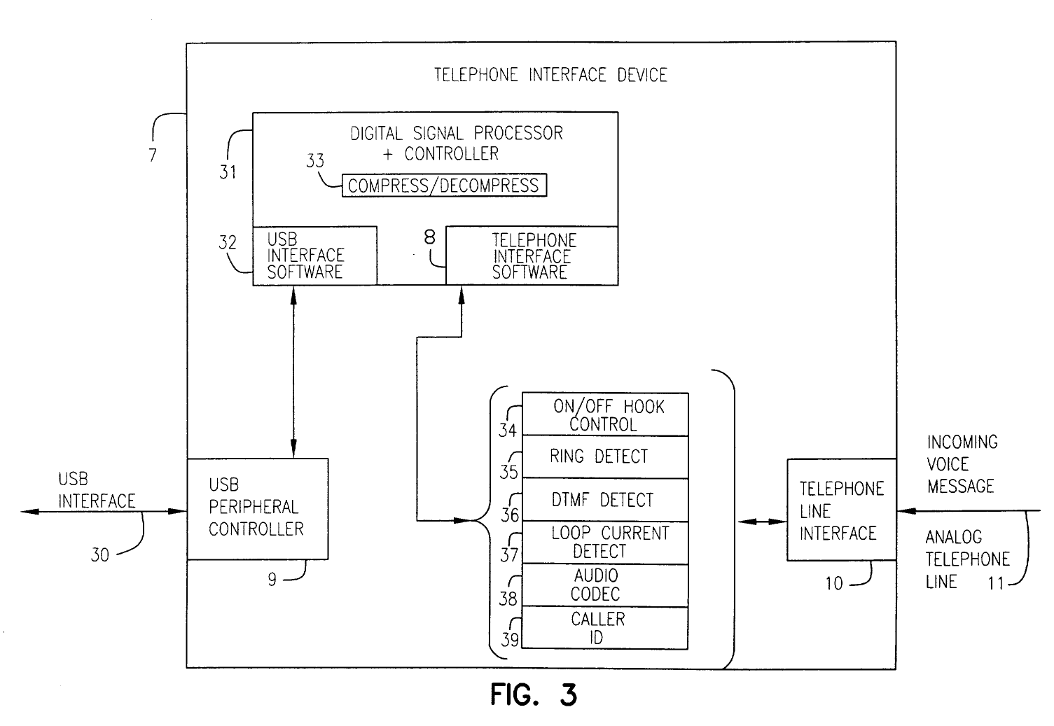

As shown in FIG. 1, TID 7 includes telephone interface software 8, USB peripheral controller 9, and telephone line interface 10. TID 7 is described more fully below with reference to FIG. 3.

As shown in FIG. 1, remote email computer 14 includes audio player application software 15, client email software 16, storage 17, sound card 18, and modem or Internet connection 19. The operation of remote email computer 14, and the interoperation of remote email computer 14 with the rest of system 100 are explained below.

In operation, application software 2 and TID 7 interoperate for collecting voice mail; email application software 3 and modem/Internet connection 6 interoperate for creating voice mail attachments and sending “voice email;” and remote email computer 14, modem/Internet connection 19, and audio application software 15 interoperate for receiving the voice email and playing the attached voice file.

FIG. 2 shows a more detailed view of a voice email server. Voice email server 1 includes voice mail application software 2, email application software 3, processor 50, memory 52, voice mail storage 4, USB software driver 28, USB host controller 5, email client software 29, and modem or Internet connection 6.

Processor 50 represents a processor capable of executing the various software blocks shown in FIG. 2. Memory 52 represents an article that includes a machine-accessible medium. For example, memory 52 may represent any one or more of the following: a hard disk, a floppy disk, random access memory (RAM), read only memory (ROM), flash memory, CDROM, or any other type of article that includes a medium readable by a machine. Memory 52 may store instructions for performing the execution of the various method embodiments of the present invention.

Voice email server 1 can be implemented using a computer, such as a personal computer (PC) or workstation. It is configured to be both a voice mail server with application software 2 and an email server with application software 3. Both applications may be capable of functioning at the same time, but this is not a limitation of the present invention.

A conventional voice mail process is used to capture incoming calls when a user is not present to answer his telephone. This voice mail system includes a voice email server 1 with voice mail application software 2 that is used to control one or more telephone interface devices 7 through a USB interface. A USB interface 30 works well as the interface between the computer server 1 and the telephone interface device 7 because USB is economical and is common on most present day computers and the interface can allow connection to multiple other telephone interface devices 7 if additional voice mail ports are desired. Most early vintage voice mail systems use telephone interface cards that plug into ISA or PCI buses within the computer. These other hardware interface cards will work adequately but the ISA bus is disappearing on present day computers and both buses require that cards be installed inside the computer, making for a more difficult installation. In addition, as other devices are plugged into existing bus slots, there may not be enough slots available for all of the desired telephone interface devices.

USB interface 30 is shown in FIG. 2 as an example of a suitable interface. Other suitable interfaces exist, and are contemplated for use in various embodiments of the present invention. For example, other types of serial, parallel, or networking ports may be used, including, but not limited to, Firewire, Ethernet, and as-yet-undefined future interfaces.

The telephone interface device 7 provides a direct connection to an analog telephone line 11 and performs all of the normal telephone interface functions including ring detect, on and off hook connection to the phone line, caller ID capture, DTMF detect, loop current detect and analog-to-digital and digital-to-analog conversion of the audio. In a preferred embodiment, all high level control of the TID 7 device is performed by the application software 2. In this embodiment, primitive commands with default settings, fail safe backups of important functions such as “on and off hook control” and some processing functions that can be more quickly performed in the TID are controlled within the TID. This allows for proper control of the telephone line interface during power-up and in the event that the voice email server is not functioning.

Upon power-up of the voice email server 1, application software 25 establishes proper connection with the TID 7. This is accomplished through the interface with the USB software driver 28 and USB host controller 5. At this point, the application software 25 is receiving status information from and sending control information to the TID 7. The TID 7 smoothly accepts the transition in control from the email server 1.

In a preferred embodiment, information being sent from the TI) 7 to the voice email server 1 includes:

ring detect status;

confirmation of on or off hook status;

loop current detect;

DTMF detect status;

received digitized audio from phone line;

optional audio volume or tone detect from the phone line; and

optional caller ID information.

Information being sent from the voice email server 1 includes:

on or off hook control; and

digitized audio to be played onto the phone line;

Also at power-up of the voice email server 1, the voice mail application software 2 may display an information and control screen for communication with the user. This graphical user interface (GUI) communicates status and setup information to the user. It also gives the user overall on/off control of the voice mail answering system for the phone line and it should provide overall on/off control of the sending email portion of the system.

In general, the telephone interface device control software 25 is continuously monitoring the TID 7 for ring-in. When a predetermined number of rings is reached, the software 25 commands the TID 7 to go off-hook and answer the incoming call. The software 25 also retrieves the caller ID information if present. The software 2 retrieves the greeting message to be played from voice mail storage 4 and optionally decompresses 24 the audio file. The audio file to be played is transmitted over the USB interface 30 to the TID 7, which optionally decompresses and plays the audio onto the telephone line. The caller listens to the greeting, which may further request the caller to identify the mail box number for the desired destination. If the mail box number has been requested from the caller, then the TID 7 is monitored for DTMF signals entered by the caller, thereby indicating an associated mail box number. The telephone interface device control software 25 continuously monitors the TID 7 for audio energy, tones and loop current. It also receives the digitized and optionally compressed (encoded) audio data stream. The application software 24 can optionally compress the audio if this has not already been done by the TID 7. After playing the greeting, the software 2 begins to store the digitized/compressed data stream from the phone line into the voice mail storage 4 as a unique file. This indicates that the caller has begun to talk and is leaving a voice mail message. The audio energy should be continually monitored during the storage process for an energy level below a threshold value for a predetermined period of time. This indicates that the caller has finished leaving a message. The telephone interface device control software 25 may also monitor loop current in the TID 7. If the loop current disappears for a predetermined time interval, then the caller is assumed to have disconnected from the call, and the storage of the audio is ended and the TID 7 is instructed to go on-hook. Another indicator of caller disconnect is an extended period of a continuous tone, such as dial-tone. Monitoring for several different characteristics of the disconnect process ensures that the recording does not continue long after the caller has finished speaking. The application software 2 can optionally shorten the stored voice mail message by the length of time used for determination of low audio energy or continuous audio tone.

At this point, a valid voice mail message is stored in the voice email server 1 computer memory with a unique file name. The voice mail message is available for 5 permanent storage on the server 1, for playback over the TID 7 as per standard playback in a voice mail system, or to be sent to the user's email address as an email attachment.

FIG. 3 shows detail of a telephone interface device (TID) 7. A digital signal processor and controller (DSP) 31 directly controls all of the telephone interface functions that interface with analog telephone line 11. The DSP 31 also interfaces with the USB peripheral controller 9 via USB interface software 32 in order to receive and send information from the telephone interface device control software 25 on the voice mail server 1. DSP 31 is shown with USB interface software 32, telephone interface software 8, and compress/decompress block 33. These portions of DSP 31 represent a memory device capable of holding the various software programs. The memory represents an article that includes a machine-accessible medium. For example, the memory may represent any one or more of the following: a hard disk, a floppy disk, random access memory (RAM), read only memory (ROM), flash memory, CDROM, or any other type of article that includes a medium readable by a machine. The memory may store instructions for performing the execution of the various method embodiments of the present invention.

In the powered-down state of the TID 7, the hook control remains in the on-hook state. Upon power-up of the TID 7, the DSP 31 continues to keep the hook control in the on-hook state. The USB interface software 32 then attempts to establish connection with the telephone interface device control software 25 on the voice mail server 1 through the USB peripheral controller 9. Once a valid connection is established, then control of the TID 7 is turned over to the telephone interface device control software 25. The TID 7 should continue to monitor this valid connection for a shut down in communication and be ready to terminate an off-hook connection if communication with the server 1 is lost.

An incoming call is detected by the DSP 31 via the ring detect circuit 35 and communicated through the USB interface 30 to the telephone interface device control software 25. The software 25 decides when to answer the incoming call based on the number of rings and possible distinctive ringing. The software 25 commands the DSP 31 to answer the telephone call. This is accomplished by the DSP 31 directing the relay in the on/off hook control 34 into an off-hook state. The call has now been answered.

At this point, software 25 should play a greeting message by sending compressed or uncompressed digitized audio through the USB interface 30. The DSP 31 receives the digitized audio, optionally decompresses it and sends the signal to the audio codec 38, which plays the audio onto the telephone line 11. The played audio message may request that the caller further identify the desired mailbox. The DSP 31 may continuously listen for DTMF signals issued by the caller via a DTMF detect circuit 36 that can be implemented in either hardware or software. The DTMF information is passed on to software 25, which then is able to determine the final mailbox destination. Standard voice mail functions can be performed by playing prompting messages onto the phone line and listening for DTMF signal responses from the caller.

After the final greeting message is played, the software 25 instructs the DSP 31 to begin digitizing and optionally compressing the analog audio from the phone line and send it to the software 25. At the same time, the DSP 31 may optionally begin to detect the presence of voice audio energy or of continuous tones indicating a possible phone disconnect or hang-up and communicate this information to software 25. (Software 25 could optionally determine the presence of voice or tones without assistance from the DSP 31.) Software 25 can begin recording immediately after playing the greeting or it can determine when the caller starts talking and begin recording at that time. The software 25 is now saving the digitized and optionally compressed audio. Software 25 now determines when to stop recording. This can be determined by monitoring for the absence of voice audio energy for a period of time. The software will stop saving the file when talking has stopped for a period of time. The software 25 also monitors for the absence of loop current 37 which may indicate that the telephone central office has terminated the call. The software 25 may also look for a continuous tone, which is likely to indicate the termination of a call. The software 25 will finally instruct the DSP 31 to terminate the call by forcing on/off hook control 34 into an on-hook state. The incoming voice mail message has now been answered, digitized, optionally compressed and stored in nonvolatile memory on the voice mail server 1 for further action.

A unique file name is given to the voice mail file. A unique file extension such as “vox” is added to the file name to indicate the audio compression format. Caller ID information along with time and date stamp information can be saved as part of the file or optionally, a second associated file with a different file extension, such as “txt”, can be used to contain this additional information.

The GUI user interface for the voice mail server 1 optionally displays a list of the voice mail messages that are stored on the computer. It can be advantageous to be able to play these messages over the server sound card by some form of file selection. It can be further advantageous to be able to individually delete or transfer these files to other directories for storage and later reference. In one embodiment, icons or status symbols change state to indicate if the observed file has or has not been sent as an email attachment. Adding these features to the server 1, while not necessary, can make the product more flexible and useful to the user.

The voice email creation software 27 creates the email that is to be sent. The software creates a text body for the email that, in one embodiment, explains the content of the email. It may include a time and date stamp to indicate when the message was received. It may also contain the captured caller ID information if available and optionally a web link for downloading the player application software. The latter information allows the email to be forwarded and played by other parties not already possessing the player application software. In one embodiment, an email subject is created that optionally identifies the email as an electronic voice mail file. The subject can optionally include caller ID information so that the caller can be quickly identified, thereby allowing important voice mails to be played first. Lastly, the software may optionally encrypt the compressed or uncompressed audio file for security purposes. Preferably, the voice mail message is stored in a compressed format so that the file size is small and is able to be sent and received in a timely manner, in the event that slower dialup modems are used for transfer of the email. The software then adds the audio file as an attachment to the email. The electronic voice mail message in the form of an email is now ready to be sent.

The voice email control software 26 can be configured to send the electronic voice mail messages after every voice mail is received, or at intervals of time per the configuration settings in the server 1. The sending of email can also be disabled. The email is sent to the email address for the owner of the voice mailbox and to other email addresses that may be listed in the “copy to” section of the configurations or setup screen. If the mailbox owner has enabled the “send audio email” feature and a new voice mail message is present, then the voice email creation software 27 will create and send the email.

After the email has been created, it is passed to the email client software 29 which may be part of the email application software 3 or it may be an existing email client on the computer. The email client software 29 controls the modem or Internet connection 6 to send the email over the analog telephone line or Internet interface 12.

Referring now back to FIG. 1, the email is received by an Internet service provider 13 of the sender, which in turn routes the email over the Internet 23 to the destination Internet service provider 22. At this point, the email is temporarily stored at Internet service provider 22 and is ready for retrieval by the mailbox user or other copied recipients.

The mailbox user can retrieve the email anywhere that the user has access to the Internet. The user connects his remote email computer 14 to an analog telephone line or other Internet interface 21. The user then starts his client email software 16 and commands the software to make a modem or other Internet connection 19 with the Internet service provider 40. The client email software 16 is then commanded to retrieve any email stored by the Internet service provider 22. Any emails stored at Internet service provider 22 are retrieved and stored in nonvolatile memory 17 on the remote email computer 14.

The user can view the subject and text portion of the email with the client email software 16. This will identify to the user that the email contains a voice mail attachment, the time and date stamp of the voice mail and optionally, caller ID information about the original caller. The web location of audio player application software 15 may optionally be displayed in the text body of the email.

In order to play the attached voice mail, the user has an audio player application software 15 that is able to decompress, decrypt and play the attached audio file. The user views the attached voice mail audio file from the client email software 16 and “double clicks” on the attachment. The audio player application software 15 opens the audio file, begins decrypting and decompressing the audio and then plays the audio over the standard sound card 18 and is heard over a headset or speaker 20 plugged into the sound card. The player allows the user to stop or repeat the playing of the message.

The email with voice mail attachment can be saved, deleted or forwarded to another email address. Any additional individuals that receive the voice email message will be required to have the audio player application software 15 installed on their computer. The audio player application software 15 can be optionally downloaded from the Internet by clicking on a web site link included in the text portion of the email.

The original voice mail message has now been forwarded to one or more email addresses and has been retrieved by a remote computer or computers for listening at those remote computer locations, for storage on those computers or for forwarding to other locations.

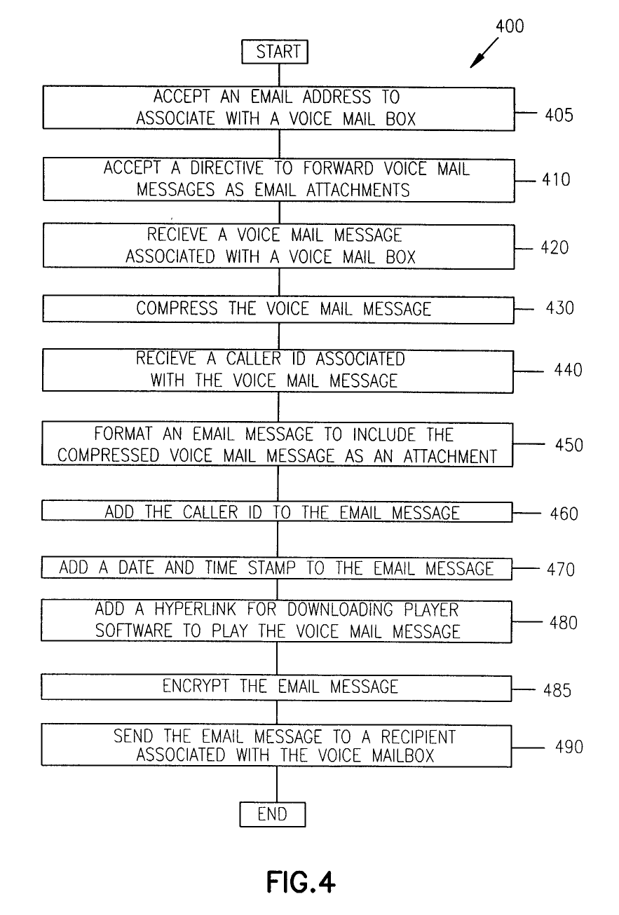

FIG. 4 shows a flowchart of a method in accordance with various embodiments of the present invention. In some embodiments, method 400 is performed by a voice email server such as voice email server 1 (FIGS. 1 and 2). In other embodiments, method 400 is distributed across multiple devices such as voice email server 1 and telephone interface device 7 (FIGS. 1 and 3). The various actions in method 400 may be performed in the order presented, or may be performed in a different order. Further, in some embodiments, some actions listed in FIG. 4 are omitted from method 400.

Referring now to FIG. 4, an email address is accepted and associated with a voice mailbox, as shown at 405. At 410, a directive is accepted. The directive directs the method to forward voice mail messages as e-mail attachments. Blocks 405 and 410 correspond to the GUI user interface described above with reference to the previous figures. These actions, among others, set up a voice mailbox to forward voice mail messages as email attachments.

At 420, a voice mail message associated with a voice mailbox is received, and the voice mail message is compressed at 430. Block 430, like the other blocks in method 400, is optional. Further, the compression can occur in one of many places. For example, referring now back to FIG. 1, compression can occur in voice email server 1 or telephone interface device 7.

At 440, a caller ID associated with the voice mail message is received. The caller ID associated with the voice mail message corresponds to the identification of the caller leaving the message.

At 450, an email message is formatted to include the compressed voice mail message as an attachment. The caller ID is added to the email message at 460, and a date and time stamp is added to the email message at 470. A hyperlink pointing to a player capable of playing of the voice mail message is included in the email message in block 480, and the email message is optionally encrypted at 485. In block 490, the email message is sent to a recipient associated with the voice mailbox.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
receiving a voice mail message associated with a voice mail box;
receiving a caller ID associated with the voice mail message;
formatting an email message to include the voice mail message as an attachment, and to include the caller ID; and
sending the email message to a recipient associated with the voice mail box.

2. The method of claim 1 wherein receiving a voice mail message comprises receiving a compressed voice mail message.

3. The method of claim 1 further comprising compressing the voice mail message to attach a compressed voice mail message to the email message.

4. The method of claim 1 further comprising adding the caller ID to a body of the email message.

5. The method of claim 1 further comprising adding the caller ID to a subject of the email message.

6. The method of claim 1 further comprising encrypting the email message prior to sending.

7. The method of claim 1 further comprising setting up the voice mail box, wherein setting up the voice mail box includes:
accepting an email address to associate with the voice mail box; and
accepting a directive to forward voice mail messages as email attachments.

8. An article having a machine-readable medium, the machine readable medium having method instructions stored thereon, the method comprising:
receiving a voice mail message;
compressing the voice mail message to produce a compressed voice mail message; and
emailing the compressed voice mail message to a recipient.

9. The article of claim 8 wherein emailing the compressed voice mail message comprises periodically emailing unsent compressed voice mail messages.

10. The article of claim 8 wherein the method further comprises receiving a caller ID.

11. The article of claim 10 wherein emailing the compressed voice mail message further comprises emailing the caller ID.

12. The article of claim 8 wherein the method further comprises encrypting the compressed voice mail message.

13. The article of claim 8 wherein the method further comprises emailing a date and time stamp corresponding to the voice mail message.

14. The article of claim 8 wherein emailing includes emailing a hyperlink for downloading player software to play the voice mail message.

15. A telephone interface device comprising:
a voice email server interface to communicate with a voice email server;
a telephone line interface to communicate with a telephone line; and
a controller to manipulate the telephone line interface in response to the voice email server interface, wherein the controller is configured to perform a compression operation on the voice mail message.

16. The telephone interface device of claim 15 wherein the telephone interface device is configured to receive incoming calls on the telephone line, digitize a voice signal to create a voice mail message, and send the voice mail message to the voice mail server.

17. The telephone interface device of claim 16 wherein the controller comprises a digital signal processor.

18. The telephone interface device of claim 15 wherein the compression operation comprises a μlaw compression operation.

19. The telephone interface device of claim 15 wherein the compression operation comprises an adaptive delta pulse code modulation compression operation.

20. The telephone interface device of claim 15 wherein the voice email server interface comprises a universal serial bus interface.

21. The telephone interface device of claim 15 further comprising a memory to hold instructions for the controller, which when read cause the controller to compress digitized voice signals received from the telephone line interface.

22. A voice email system comprising:
a voice email server; and
a telephone interface device adapted to be coupled to a telephone line and to the voice email server;
wherein the voice email server includes a voice mail storage device to store voice mail messages, and an Internet connection device to send the voice mail messages to a remote email computer.

23. The voice email system of claim 22 wherein the telephone interface device includes compression circuitry to compress the voice mail messages.

24. The voice email system of claim 23 wherein the compression circuitry includes a digital signal processor.

25. The voice email system of claim 22 wherein the voice email server includes compression circuitry to compress the voice mail messages.

26. The voice email system of claim 22 wherein the voice email server is configured to be responsive to voice mail application software to collect the voice mail messages, and to be responsive to email application software to email the voice mail messages.
